(19) United States
(12) Patent Application Publication
(10) Pub. No.: US 2013/0321259 A1
(43) Pub. Date: Dec. 5, 2013

(54) Double Sided Advertisement Billboard for Parking Lots

(71) Applicant: Ty J. INSKO, Irvine, CA (US)

(72) Inventor: Ty J. INSKO, Irvine, CA (US)

(21) Appl. No.: 13/629,166

(22) Filed: Sep. 27, 2012

Related U.S. Application Data
(60) Provisional application No. 61/654,990, filed on Jun. 4, 2012.

(51) Int. Cl. G09F 15/00; G09G 5/00

(52) U.S. Cl. 345/156; 40/606.18

(57) ABSTRACT

A Double Sided Advertisement Billboard for Parking Lots is a viewing panel that is positioned between two opposite parking spaces and elevated off the ground by supports in order to display advertising materials to people utilizing the parking spaces. The viewing panel has two opposite sides with identical components which can have different advertisements displayed utilizing different methods, including digital screens, poster boards, product cutouts or other features such as neon signs. A motion sensor detects the presence of a vehicle in the parking space in order to activate a light, screen or speaker. A user interface allows viewers to participate in interactive advertisements.

The current application claims a priority to the U.S. Provisional Patent application Ser. No. 61/654,990 filed on Jun. 4, 2012.

### FIELD OF THE INVENTION

The present invention relates generally to an apparatus for advertisements. More specifically, the present invention is an apparatus that allows double-sided billboards to display advertisements in front of or between parking spaces in a parking lot.

### BACKGROUND OF THE INVENTION

Advertising is defined as a form of communication for marketing and used to encourage or persuade an audience to continue or take some new action. In today's world, advertising generally refers to an attempt to influence consumer behavior with respect to a commercial offering, such as the purchase of a product or service, though political and ideological advertising is also common. Advertising may also be geared toward reassuring employees, shareholders or the general public that a company is viable or successful. Advertisements are generally financed by sponsors and encountered in a wide range of media, including mass media such as newspaper, magazines, television commercials, radio advertisements, outdoor advertising or direct mail, or new media such as weblogs, websites or text messages.

One common method of advertising is through the use of billboards to display various messages typically consisting of a combination of texts and graphics. Traditionally, billboards are placed in larger areas and are designed to be seen by large quantities of people. However, advertisers have yet to maximize all available space for advertising to consumers. One type of area that is not commonly utilized for advertising is parking garages, parking lots and other similar areas. Parking garages and parking lots are often high-traffic areas, such as in the case of a mall or shopping center. Each parking space presents an opportunity to display an advertisement to people entering, leaving or walking by the parking space. This potential advertising space could be of mutual benefit to advertisers and property owners, since the property owners would receive revenue from selling advertising space, and the advertisers would have increased opportunity to spread their message and possibly increase their sales or company value. It is therefore an object of the present invention to provide an apparatus for displaying advertisements that can be placed in front of or between parking spaces.

### BRIEF DESCRIPTION OF THE DRAWINGS

FIG. 1 is a top view of the first embodiment of the present invention.

FIG. 2 is a perspective view of the first embodiment of the present invention with an example advertisement being displayed on the first side.

FIG. 3 is a perspective view of the second embodiment of the present invention with multiple advertising spaces on the first side.

FIG. 4 is a perspective view of the second embodiment of the present invention with multiple example advertisements on the second side.

FIG. 5 is a perspective view of the third embodiment of the present invention.

FIG. 6 is a schematic diagram showing the electronic components of the first embodiment of the present invention.

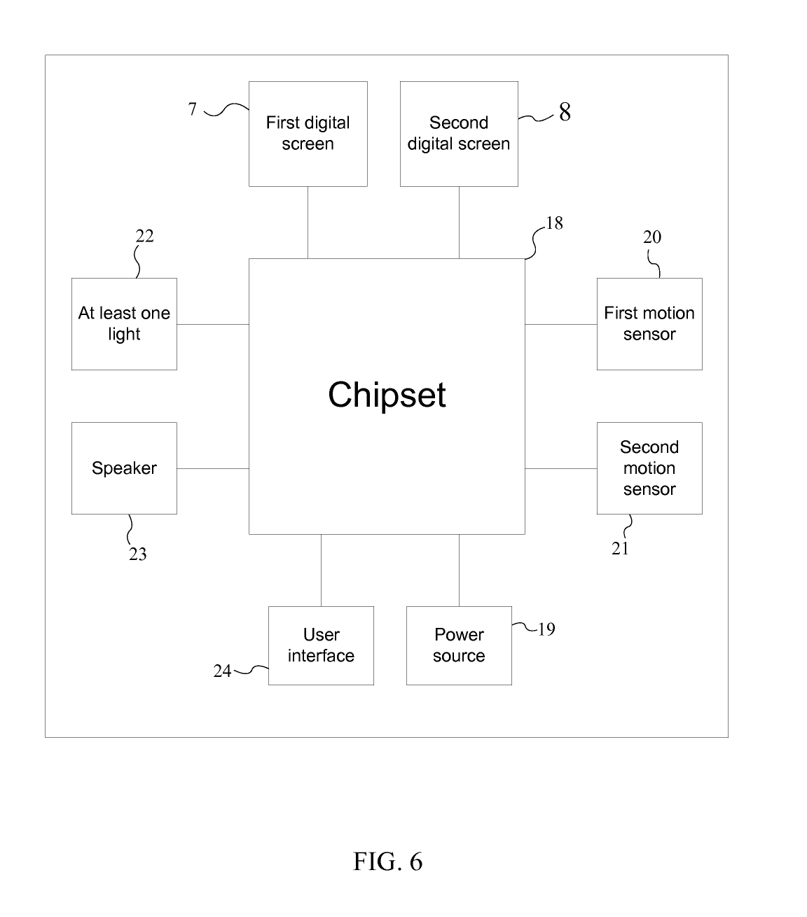

FIG. 7 is a schematic diagram showing the electronic components of the second embodiment of the present invention.

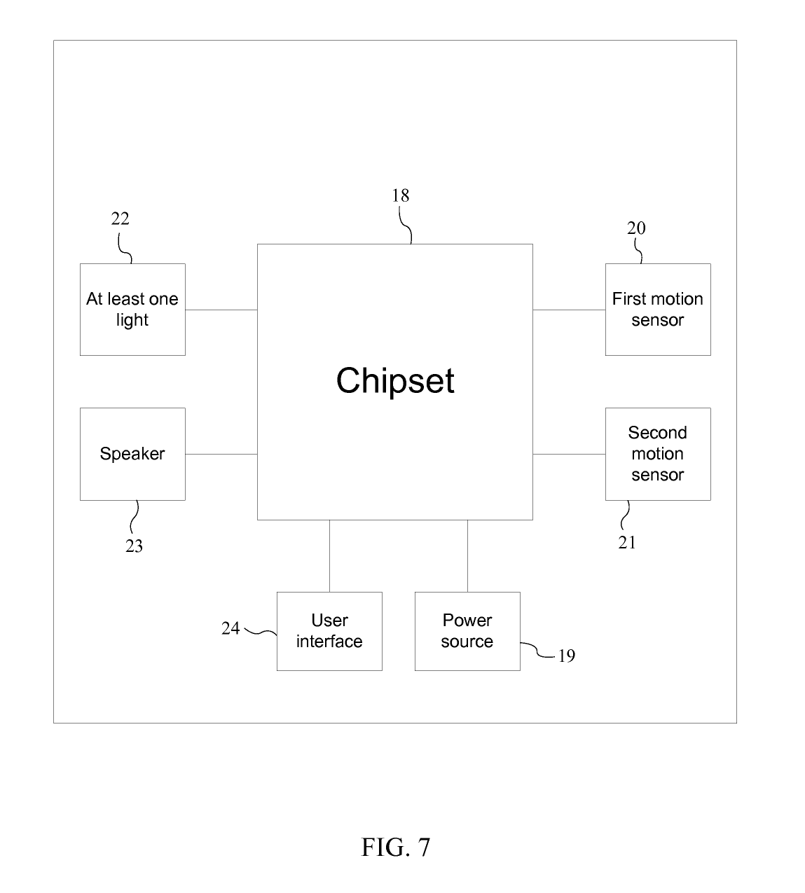

### DETAIL DESCRIPTIONS OF THE INVENTION

All illustrations of the drawings are for the purpose of describing selected versions of the present invention and are not intended to limit the scope of the present invention.

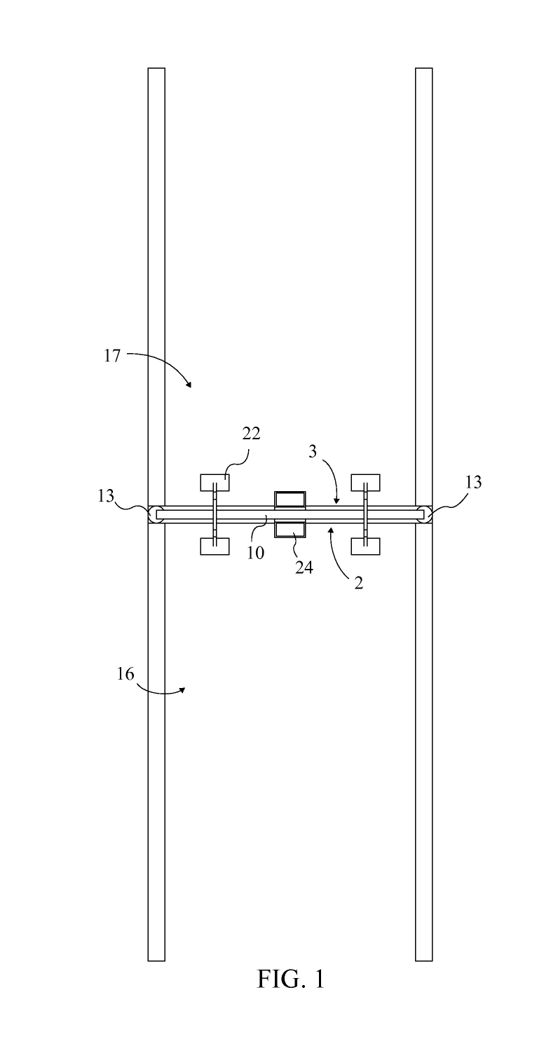

Referring to FIGS. 1-5, the present invention is a double sided advertisement billboard for parking lots that is placed in between two rows of parking spaces. The system of the present invention generally comprises a viewing panel 1, a first advertising display 11, a second advertising display 12, a plurality of supports 13, a first parking space 16, and a second parking space 17. The viewing panel 1 comprises a first side 2 and a second side 3. The first side 2 of the viewing panel 1 is positioned adjacent to the first parking space 16. The second parking space 17 is positioned opposite from and parallel to the first parking space 16 adjacent to the second side 3. The first side 2 and the second side 3 are positioned opposite each other on the viewing panel 1. The viewing panel 1 is adjacently positioned between the first parking space 16 and the second parking space 17. The first advertising display 11 is positioned adjacent to the first side 2 and the second advertising display 12 is positioned adjacent to the second side 3. The viewing panel 1 is connected atop the plurality of supports 13, so that the viewing panel 1 is raised to an elevation appropriate for easy viewing by passersby, preferably at or above the level of a typical car windshield. In a common arrangement of parking spaces, the first parking space 16 and the second parking space 17 are opposite and parallel to each other. Other parking space arrangements such as slanted arrangements may be encountered, but do not change the use of the invention being positioned adjacent to the inner extremity of at least one parking space. The present invention may still be utilized as a single-sided advertisement billboard in the case of a parking space or row of parking spaces that is not positioned adjacently opposite a second parking space or row of parking spaces, such as a row of parking spaces positioned against a sidewalk, a curb, a wall, or a building.

The first advertising display 11 and the second advertising display 12 comprise advertising materials 6. The advertising materials 6 are any pre-made materials that are feasible for displaying on the present invention, such as, but not limited to, posters, cut out displays, neon signs, or digital displays.

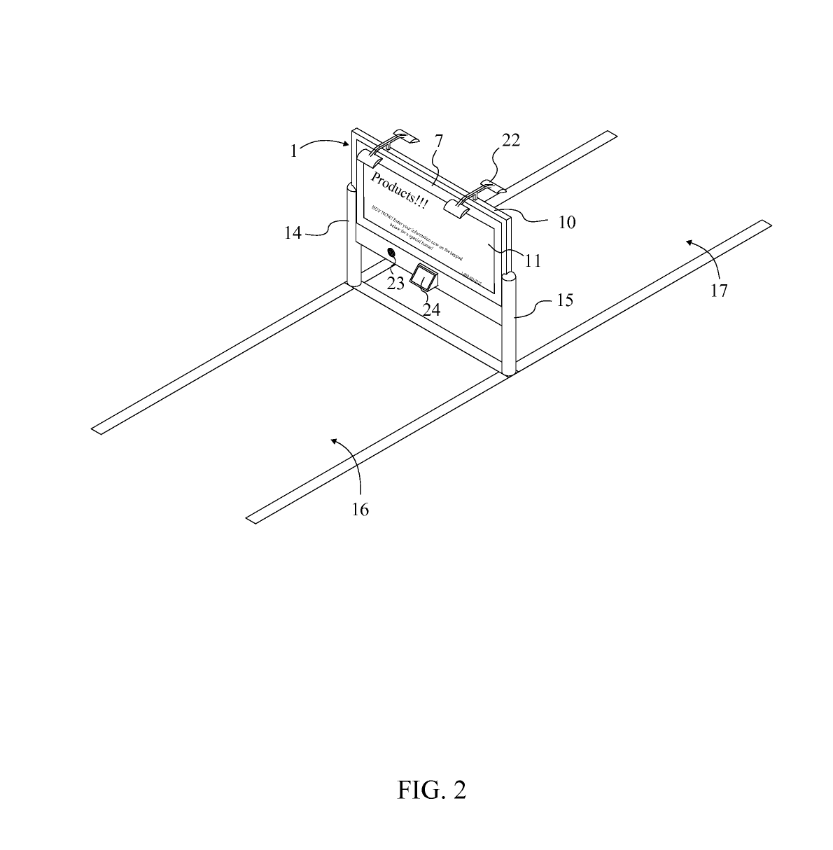

The preferred embodiment of the present invention also comprises an electronics housing 10, a chipset 18, a power source 19, a first motion sensor 20, a second motion sensor 21, at least one light 22, a speaker 23, and a user interface 24. Referring to FIG. 2, in a first embodiment of the present invention, the viewing panel 1 comprises a first digital screen 7 and a second digital screen 8 that are electronically controlled by the chipset 18. The first digital screen 7 is positioned on the first side 2 and the second digital screen 8 is positioned on the second side 3.

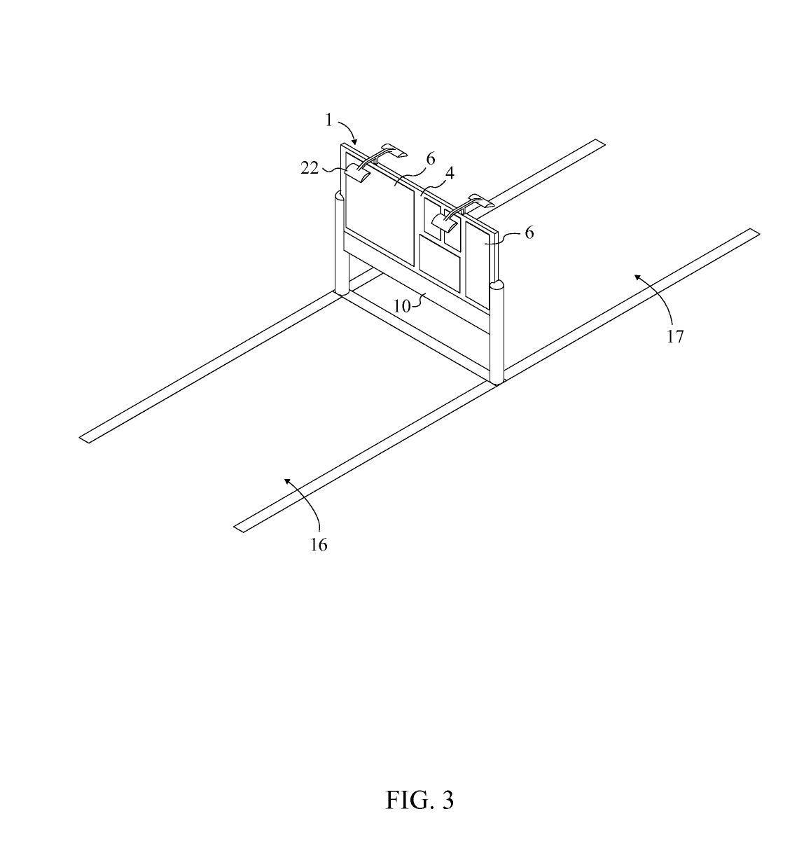

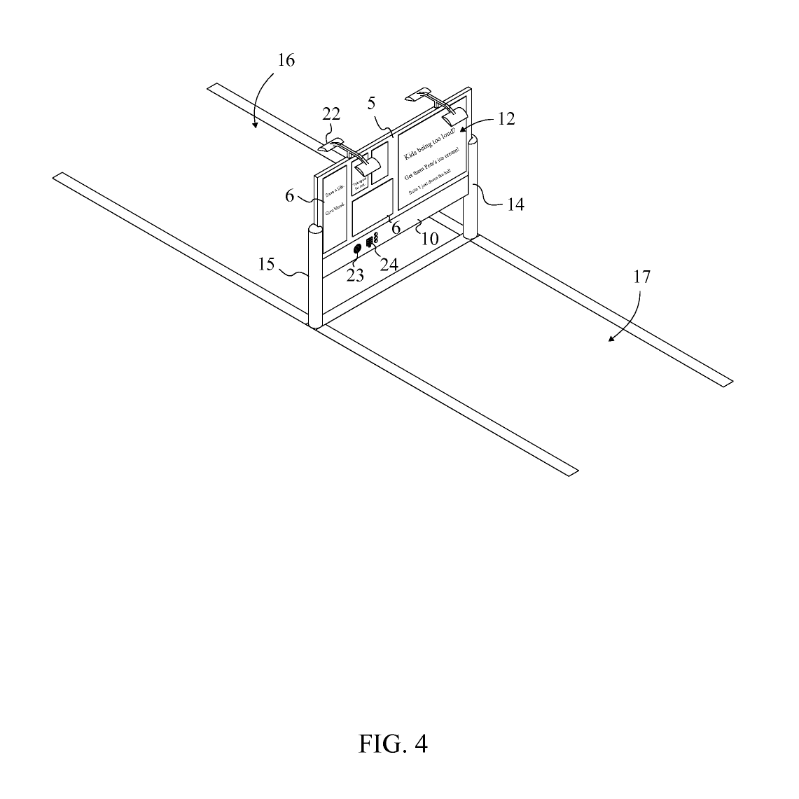

Referring to FIGS. 3-4, in a second embodiment of the present invention, the viewing panel 1 comprises a first poster board 4 and a second poster board 5 to which physical advertising materials 6 such as posters, flyers or other materials may be affixed.

The first poster board 4 is positioned on the first side 2 and the second poster board 5 is positioned on the second side 3.

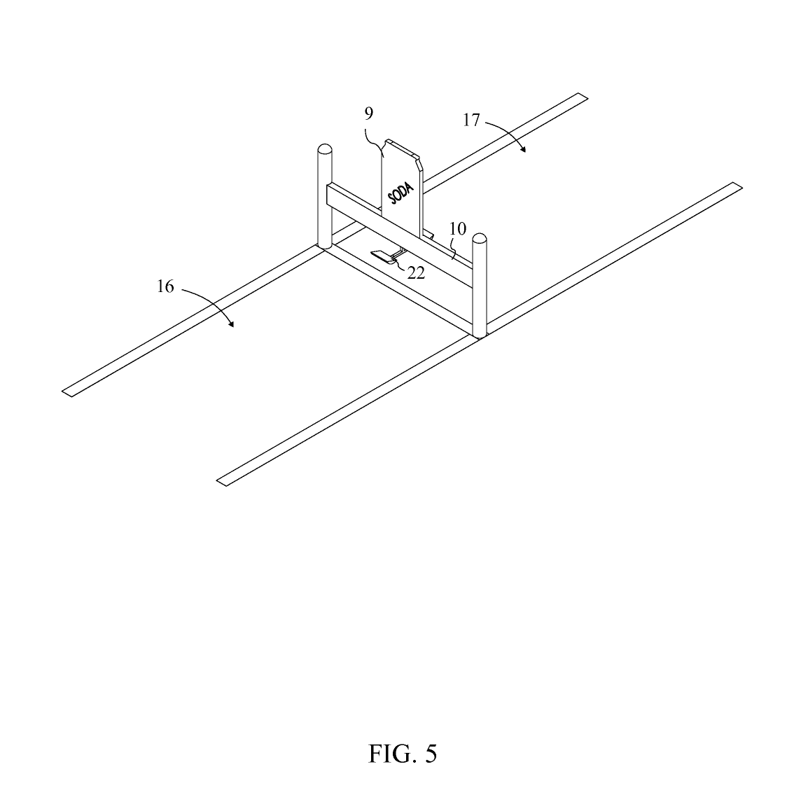

Referring to FIG. 5, in a third embodiment of the present invention, the viewing panel 1 is a cutout 9 of specific shape, such as, but not limited to, a soda can, a vehicle, a piece of furniture, a person, or a neon sign made using electrified, luminous tube lights that contain rarefied neon or other gases.

The viewing panel 1 comprises at least one commonly known attachment method that facilitates the viewing panel 1 being easily attached to and detached from the plurality of supports 13 or to the electronics housing 10, such as, but not limited to, a latch mechanism or concentric holes in the viewing panel 1 and the plurality of supports 13, the electronics housing 10 or the screen frame 25 for affixing the viewing panel 1 and the plurality of supports 13 together using nuts and bolts.

As can be seen in FIG. 2, the first embodiment of the present invention comprises a screen frame 25 that is connected atop the electronics housing 10 and perimetrically connected around the viewing panel 1. As can be seen in FIGS. 3-4, in the second embodiment of the present invention, the viewing panel 1 is connected atop the electronics housing 10. In alternate embodiments, the electronics housing 10 is part of one or more of the plurality of supports 13.

The plurality of supports 13 comprises a first end support 14 and a second end support 15. The first end support 14 and the second end support 15 are positioned opposite each other at the lateral extremities of the viewing panel 1. In the first embodiment of the present invention, the first end support 14 and the second end support 15 are connected to the electronics housing 10 and the screen frame 25, which in turn support the viewing panel 1. In the second embodiment of the present invention, the first end support 14 and the second end support 15 directly support the viewing panel 1, and the electronics housing 10 is also connected to the first end support 14 and the second end support 15 but positioned beneath the viewing panel 1. In the preferred embodiment of the present invention, the viewing panel 1 is positioned generally above and in between the supports. The plurality of supports 13 may be of any appropriate height, or the plurality of supports 13 may be of adjustable height utilizing a mechanism such as, but not limited to, a spring-loaded pin and series of mating holes, or a hydraulic mechanism. In an alternate embodiment of the invention, the viewing panel 1 comprises a plurality of modular sections that can be moved or interchanged.

The chipset 18 is a component or combination of components of the electronic variety such as, but not limited to, circuit boards, wires, and processors necessary to facilitate the translation of electrical input signals into desired effects in the operation of the system. The chipset 18 receives electrical inputs from various sources, such as, but not limited to, the first motion sensor 20, the second motion sensor 21 and the user interface 24, processes the inputs, and produces the appropriate outputs, such as, but not limited to, signals to control the viewing panel 1, signals to control the at least one light 22, signals to play audio through the speaker 23, or commands through a network connection to perform functions such as, but not limited to, sending an email, or adding an email address, phone number or other information to a database, where said information would be received through the user interface 24.

In the preferred embodiment of the invention, the chipset 18 may be able to be connected to the world wide web or another digital, wired or virtual network through an appropriate network connection, such as, but not limited to, an ethernet cable, a Wi-Fi connection or another wireless short-wavelength radio connection. The present invention may facilitate interactive advertisements, where viewers may be prompted to provide input, such as answering a question or adding a phone number, email, or other information to a database. Any viewer input is received by the chipset 18 through the user interface 24. The user interface 24 may comprise a number of physical buttons positioned on the electronics housing 10, or the user interface 24 may comprise a digital touch screen that is either part of the viewing panel 1 or that is a separate input panel connected to the electronics housing 10 or viewing panel 1, or another appropriate input method. The user interface 24 may also comprise a microphone for recording audio messages by viewers, a mouse or other cursor tracking device, or a joystick.

The power source 19 provides electrical power to the electronic components of the present invention, including, but not limited to, the viewing panel 1, the chipset 18, the first motion sensor 20, the second motion sensor 21, the at least one light 22, the speaker 23, and the user interface 24. The power source 19 may be a permanent wired electrical connection, the power source 19 may comprise a battery pack, or a combination of different power sources may be used.

The first motion sensor 20 and the second motion sensor 21 are devices that detect the presence of a person or vehicle in order to activate electrical components of the present invention, including, but not limited to, the digital screen, the chipset 18, the at least one light 22, or the speaker 23. The first motion sensor 20 and the second motion sensor 21 may be communicatively connected to the chipset either through physical wires or a wireless connection such as a connection utilizing paired short-wavelength radio transmission devices. The first motion sensor 20 is positioned adjacent to the first side 2 to detect motion in the first parking space 16 and the second motion sensor 21 is positioned adjacent to the second side 3 to detect motion in the second parking space 17. The first motion sensor 20 and the second motion sensor 21 may comprise a number of different appropriate motion detection methods, including, but not limited to, a weight sensor placed under the parking space to detect the presence of a vehicle, acoustic sensors, infrared light or laser sensors, or thermal sensors. When the first motion sensor 20 or the second motion sensor 21 sends a detection signal to the chipset 18, the chipset 18 sends electronic signals to activate appropriate electronic components of the present invention, depending on the advertising materials 6 currently in use. For example, in the first embodiment of the present invention, when motion is detected, the digital screen turns on, or the at least one light 22 turns on, or both, and the speaker 23 may play an audio recording to help attract the attention of the passersby. In alternate embodiments of the present invention that do not comprise a digital screen, the at least one light 22 turns on and the speaker 23 may play an audio recording.

The at least one light 22 may comprise any appropriate lighting method or arrangement for attracting attention to and providing a clear view of the viewing panel 1, such as a row of angled housings holding standard light bulbs, or fluorescent lamps. The at least one light 22 is preferably positioned on and supported by the electronics housing 10 or the screen frame 25.

The speaker 23 is an electro-acoustic transducer that produces sound in response to an electrical audio signal input utilizing previously known methods. The speaker 23 is preferably positioned within the electronics housing 10, with a pattern of cuts into the electronics housing 10 adjacent to the speaker 23 in order to reduce physical blockage of emitted sound waves.

In the preferred embodiment of the present invention, the first side 2 and the second side 3 of the viewing panel 1 are identical save for the fact that the first side 2 and the second side 3 may display different advertisements. If the present invention is placed in a parking garage or another location where the rows of parking spaces are not positioned adjacent to each other, then the present invention only utilizes one advertising display. Each side comprises at least one light 22, either the first motion sensor 20 or the second motion sensor 21, a speaker 23 and a user interface 24. Both sides are powered by the same power source 19 and controlled by the same chipset 18.

Although the invention has been explained in relation to its preferred embodiment, it is to be understood that many other possible modifications and variations can be made without departing from the spirit and scope of the invention as hereinafter described.

What is claimed is:

1. A system for a double sided advertisement billboard for parking lots comprises,
a viewing panel;
a first advertising display;
a second advertising display;
a plurality of supports;
a first parking space;
a second parking space;
the viewing panel comprises a first side and a second side;
the first parking space being positioned opposite and parallel to the second parking space;
the viewing panel being adjacently positioned between the first parking space and the second parking space;
the first advertising display being positioned on the first side adjacent to the first parking space;
the second advertising display being positioned on the second side adjacent to the second parking space; and
the viewing panel being connected in between the plurality of supports, wherein the viewing panel is elevated to the level of a car windshield.

2. An apparatus for a double sided advertisement billboard for parking lots comprises,
a viewing panel;
an electronics housing;
a screen frame;
a plurality of supports;
a chipset;
a power source;
a first motion sensor;
a second motion sensor;
at least one light;
a speaker;
a user interface;
the viewing panel comprises a first side and a second side; and
the plurality of supports comprises a first end support and a second end support.

3. The apparatus for a double sided advertisement billboard for parking lots as claimed in claim 2 comprises,
the electronics housing being positioned in between the plurality of supports;
the first end support being adjacently connected to the electronics housing;
the second end support being adjacently connected to the electronics housing opposite from the first end support;
the screen frame being connected atop the electronics housing;
the viewing panel being positioned within the screen frame and the electronics housing.

4. The apparatus for a double sided advertisement billboard for parking lots as claimed in claim 2 comprises,
the chipset and power source being positioned within the electronics housing;
the at least one light and the user interface being positioned on the electronics housing;
the first motion sensor being positioned adjacent to the first side;
the second motion sensor being positioned adjacent to the second side; and
the speaker being positioned adjacent to the electronics housing.

5. The apparatus for a double sided advertisement billboard for parking lots as claimed in claim 2 comprises,
the first side comprises a first digital screen;
the second side comprises a second digital screen; and
the first digital screen being positioned opposite the second digital screen.

6. The apparatus for a double sided advertisement billboard for parking lots as claimed in claim 2 comprises,
the power source being electrically connected to the viewing panel, the chipset, the first motion sensor, the second motion sensor, the at least one light, the speaker, and the user interface; and
the chipset being electronically connected to the viewing panel, the first motion sensor, the second motion sensor, the at least one light, the speaker, and the user interface.

7. An apparatus for a double sided advertisement billboard for parking lots comprises,
a viewing panel;
an electronics housing;
a plurality of supports;
a chipset;
a power source;
a first motion sensor;
a second motion sensor;
at least one light;
a speaker;
a user interface;
the viewing panel comprises a first side, a second side, and advertising materials; and
the plurality of supports comprises a first end support and a second end support.

8. The apparatus for a double sided advertisement billboard for parking lots as claimed in claim 7 comprises,
the viewing panel being positioned in between the plurality of supports;
the electronics housing being positioned below the viewing panel;
the first end support being adjacently connected to the viewing panel and the electronics housing; and
the second end support being adjacently connected to the viewing panel and the electronics housing opposite the first end support.

9. The apparatus for a double sided advertisement billboard for parking lots as claimed in claim 7 comprises,
the chipset and power source being positioned within the electronics housing;
the at least one light and the user interface being positioned on the electronics housing;
the first motion sensor being positioned adjacent to the first side;
the second motion sensor being positioned adjacent to the second side; and
the speaker being positioned adjacent to the electronics housing.

10. The apparatus for a double sided advertisement billboard for parking lots as claimed in claim 7 comprises,
the first side comprises a first poster board;
the second side comprises a second poster board;
the first poster board being positioned opposite the second poster board; and
the advertising materials being affixed to the first poster board and the second poster board.

11. The apparatus for a double sided advertisement billboard for parking lots as claimed in claim 7 comprises,
the power source being electrically connected to the chipset, the first motion sensor, the second motion sensor, the at least one light, the speaker, and the user interface; and
the chipset being electronically connected to the viewing panel, the first motion sensor, the second motion sensor, the at least one light, the speaker, and the user interface.
